(19) United States
(12) Patent Application Publication
(10) Pub. No.: US 2005/0039836 A1
(43) Pub. Date: Feb. 24, 2005

(54) Multi-component fibers, fiber-containing materials made from multi-component fibers and methods of making the fiber-containing materials

(76) Inventors: Jeffrey S. Dugan, Erwin, TN (US); Garland Earley, Weaverville, NC (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/959,162

(22) Filed: Oct. 7, 2004

Related U.S. Application Data
(62) Division of application No. 09/390,289, filed on Sep. 3, 1999.

(51) Int. Cl. B32B 31/20

(52) U.S. Cl. 156/62.2; 156/309.6

(57) ABSTRACT

Disclosed are a multi-component fiber, fiber-containing (e.g., fibrous) material made of multi-component fibers, and methods of forming the fiber-containing material. The fiber-containing material is made of a plurality of multi-component fibers of at least first and second segments. The first and second segments are respectively made of different polymer materials having a high melt temperature and a low melt temperature relative to each other, and the first and second segments are splittable from each other. The fiber-containing material is made by collecting a plurality of the multi-component fibers, splitting the first and second segments from each other, and thermally bonding the fibers by melting the lower melt temperature polymer material of the first segments or second segments. The melted polymer material encapsulates cross-over points of remaining segments, of higher melt temperature polymer material, to act as a binder for the fiber-containing material. The fiber-containing material formed can be, e.g., a yarn, web or fabric, and can have improved strength and softness. According to another aspect of the present invention, a multi-component fiber is made of at least first and second segments which can be split from each other and which are respectively made of different polymer materials having different melt temperatures, a difference in melt temperature between the polymer materials of the first and second segments being, e.g., at least 100° C.

### BACKGROUND

The present invention is directed to multi-component (e.g., conjugate) fibers, fiber-containing materials (e.g., fibrous materials, such as woven fabrics, knit fabrics, yarns, webs and nonwoven fabrics) containing multi-component fibers, and methods of making such fiber-containing materials using multi-component fibers. In particular, the present invention is directed to multi-component fibers which are thermally bondable, fibrous materials such as yarns, webs and fabrics which are bonded thermally, and methods of forming these fibrous materials.

It has long been desired to provide bonded fibrous materials, including nonwovens, which have increased strength and increased softness. FIG. 1 illustrates a bonded fibrous structure, using standard size binder fibers 1. Each binder fiber 1 includes binder fiber core 3 and adhesive sheath 5. The binder fiber 1 becomes bound to bound standard size fiber 7 (which may or may not be a binder fiber, also) at cross-over bond point 9. Structure as shown in FIG. 1 has adhesive polymer distributed throughout the web of fibrous material, being located at cross-over points and at other points, binding areas much larger than just the cross-over points, and thereby reducing the ability of the bound fibers to move and reducing the softness of the bonded area.

FIG. 2a illustrates another bonded fibrous structure, using standard size binder fibers 1 and microfibers 11. In this structure of FIG. 2a, the microfibers 11 are bound to adhesive sheath 5 of binder fiber 1 at points 15; however, cross-over points 13 of the microfibers 11 of the fibrous structure of FIG. 2a are not bound at all. Because many of the potential bonding sites (cross-over points) are not bound at all, the resulting fibrous material has reduced strength. Moreover, in the structure of FIG. 2a, using standard size binder fibers 1 and microfibers 11, there is excessive adhesive and bonding of more than just the cross-over points.

FIGS. 1 and 2a show bonded structure wherein the adhesive sheath 5 of binder fiber 1 has been softened (tackified), with the bound fibers binding to the softened adhesive and remaining bound thereto after the softened adhesive has hardened. As can be appreciated from FIGS. 1 and 2a, the adhesive has softened enough to stick to the fibers touching it, but has not melted (in particular, has not melted sufficiently to flow and encapsulate the cross-over points). In particular, in the structure of FIGS. 1 and 2a the adhesive has not sufficiently (e.g., completely) melted to flow to the cross-over points and encapsulate them.

Even in structure using standard size binder fibers and microfibers 11a and 11b, with the standard size binder fibers being melted, forming melted adhesive 12, to provide the bonded structure as shown in FIG. 2b, the resultant structure has disadvantages. Thus, as seen in FIG. 2b, there is an excessive amount of binder at one spot.

U.S. Pat. No. 4,239,720 to Gerlach, et al. discloses fiber structures such as staple fibers, filaments, yarns, and sheets such as woven fabric, warp knits, webs and the like. These structures are each formed of multi-component fibers which have been subjected to splitting, to form split multi-component fibers having segments split from a matrix component.

In the multi-component fibers, the segments are embedded in the matrix. The matrix component and segments of the fibers exhibit a differential shrinkage in a solvent. By application of the solvent, and in light of the differential shrinkage, the matrix and segment components can be split from each other, forming matrix fibers and segment fibers.

U.S. Pat. No. 4,239,720 discloses that the fiber structures may be composed wholly, or in part, of completely or partially split multi-component fibers; and that if the fibers are to be bonded at their points of intersection, this is accomplished with heat. Bonding of the fibers is accomplished by partial melting of one of the polymer components, it being understood that the bonding component has a lower melting point than the non-bonding component.

U.S. Pat. No. 4,239,720 discloses that a bonded web may be made from randomly laid multi-component fibers having a polyamide matrix and segments of polyalkylene terephthalate, which are split up either wholly or partly into matrix fibers and segment fibers. Bonding of the fibers takes place at the point where segment fibers intersect with lower melting matrix fibers and where matrix fibers intersect each other; and that where segment fibers intersect with other segment fibers, bonding does not occur at the temperatures used.

In the product web formed in U.S. Pat. No. 4,239,720, the lower melting point matrix fibers extend throughout the web. In addition, in U.S. Pat. No. 4,239,720 there are cross-over points of segment (high melting point) fibers with each other, where there is no matrix material and thus no bonding. The contents of U.S. Pat. No. 4,239,720 are incorporated herein by reference in their entirety.

Also note each of U.S. Pat. No. 5,629,080 to Gupta, et al., No. 5,707,735 to Midkiff, et al. and No. 5,783,503 to Gillespie, et al., the contents of each of which are incorporated herein by reference in their entireties. These patents disclose, inter alia, multi-component fibers, used in forming fabrics or webs.

Notwithstanding the foregoing, it is still desired to provide fibers, and fibrous material (e.g., yarns, webs and fabrics), the fibrous material having improved strength and softness (desirably, having improvements in both strength and softness simultaneously), with less wasted binder material and with a more even distribution of binder for more even appearance.

### SUMMARY

According to an aspect of the present invention, there is a fiber-containing material made from a plurality of multi-component fibers. Each multi-component fiber includes at least first and second segments, the first and second segments being made respectively of a first polymer material and a second polymer material different from the first polymer material, the first polymer material having a higher melt temperature than that of the second polymer material. The difference in melt temperatures of the first and second polymer materials is, illustratively, at least 10° C., e.g., 10°-250° C. The first and second segments are at least partially split from each other, with the second segments having been melted and being a binder of the fiber-containing material. While not to be limiting, this fiber-containing material can be a fibrous material, e.g., woven and knit fabrics, a yarn, nonwoven fabric or a web.

In this fiber-containing material according to this aspect of the present invention, the second segments can be completely melted in forming the material, and the second polymer material, forming the second segments, can be the sole binder of the fiber-containing material. The fibers used in forming the fiber-containing material can be microfibers (e.g., having a denier of 1.0 or less), although the fibers need not be, and the fibers used in forming the fiber-containing material can consist of staple fibers.

Further according to this aspect of the present invention, the fiber-containing material has cross-over points of the first segments where the first segments cross each other, and the melted second polymer material, of the second segments, is concentrated at the cross-over points of these first segments of first polymer material of higher melt temperature. Desirably, the second polymer material, of the second segments, is substantially only at the cross-over points.

As indicated previously, according to this aspect of the present invention, the fiber-containing material is formed from multi-component fibers, the multi-component fibers having at least first and second segments (e.g., at least first and second sections of the multi-component fiber, extending a length of the fiber). The first and second segments are made respectively of first and second polymer materials, the second polymer material being different from the first polymer material. The first polymer material has a higher melt temperature than that of the second polymer material, the difference in melt temperatures being at least 10° C., for example, in the range of 10°-250°. The first and second segments are splittable from each other.

As a further aspect of the present invention are multi-component fibers having at least first and second segments, respectively of first and second polymer materials different from each other, the first and second polymer materials having a difference in melt temperature therebetween of at least 100° C. The first and second segments are splittable from each other.

Illustratively, and not to be limiting, each multi-component fiber can have a size in the range of 0.7 to 100 deniers per filament. Moreover, each fiber can have a plurality of the first segments and a plurality of the second segments, and, illustratively, the fiber has between 4 and 100 segments in total, more specifically, 4-64. The segments, for example, constitute the totality of the multi-component fiber.

The first and second segments of the multi-component fiber can be split from each other, either totally or partially, and, illustratively, can be split by at least one of heat and mechanical action.

A still further aspect of the present invention includes a method of forming the fiber-containing material. This method includes collecting a plurality of multi-component fibers, these multi-component fibers having at least first segments and second segments respectively made of first and second polymer materials different from each other, the first polymer material having a higher melt temperature than that of the second polymer material. The second segments are split at least partially from the first segments. The fibers are thermally bonded, to form the fiber-containing material, by melting the second polymer material of the second segments. Desirably, the second polymer material of the second segments is completely melted when thermally bonding.

In the collecting step, according to the method aspect of the present invention, the plurality of fibers are collected to form cross-over points with each other; and in the thermal bonding step the second polymer material of the second segments is melted so as to encapsulate the first segments at the cross-over points of the first segments. Desirably, in the thermal bonding step the second polymer material of the second segments is melted such that after the thermal bonding step the second polymer material of the second segments is substantially only at the cross-over points.

Illustratively, according to this aspect of the present invention the second polymer material is melted without melting the first polymer material of the first segments. Thus, the first segments maintain their structure as, e.g., micro-fibers. The second polymer material, of the second segments, encapsulating cross-over points of the first segments with each other, binds the first segments (and, accordingly, binds the fiber-containing material).

According to the present invention, improvements in strength and softness of the fiber-containing material are achieved. In many cases, improvements in both strength and softness occur simultaneously, which is particularly desirable since most ways of improving strength degrade softness and vice versa. This improved fabric strength and softness results from improved distribution and finer divisions of both load-bearing fiber segments (the non-melting component) and the melted segments. The smaller load-bearing fibers have lower bending moments than conventional, larger fibers, so the fabric is softer. The smaller fibers are also higher in number for a given fabric weight, so that there are more points at which the load-bearing fibers cross each other. Moreover, because the fiber-containing material according to the present invention places smaller amounts of adhesive at more bonding sites, and because there are more bonding sites formed, the resulting fibrous material can be made stronger and can be made softer, and can have a more even appearance. Additionally, complete melting of the second segments, which concentrates the adhesive (polymer material of the second segments) at the cross-over points of the first segments, results in individual bond strengths that are higher than strengths achieved by merely softening (tackifying) the adhesive fibers but not melting them. Through use of the splittable segmented fibers with segments of different melt temperatures, the binder fibers (micro-denier binder fibers of the split lower melt temperature material) are evenly and thoroughly dispersed in the web, and thermal bonding of the web can easily be effected by melting and solidifying the binder fibers.

### BRIEF DESCRIPTION OF THE DRAWINGS

FIG. 1 shows binder fiber bonding to another fiber, illustrating the background of the present invention.

FIGS. 2a and 2b show binder fibers bonding microfibers, also illustrating the background of the present invention.

FIGS. 3-8 illustrate various fiber cross-sections for a multi-component fiber according to the present invention.

FIG. 9 illustrates fiber-containing material formed using multi-component fibers according to the present invention, after segments of the fiber have been split but prior to thermal bonding of the fiber-containing material.

FIG. 10 illustrates fiber-containing material formed using multi-component fibers according to the present invention, after splitting the fiber segments and after thermal bonding.

FIG. 11 illustrates a process of forming fiber-containing material according to the present invention, from forming multi-component fibers through thermal-bonding and fabric take-up.

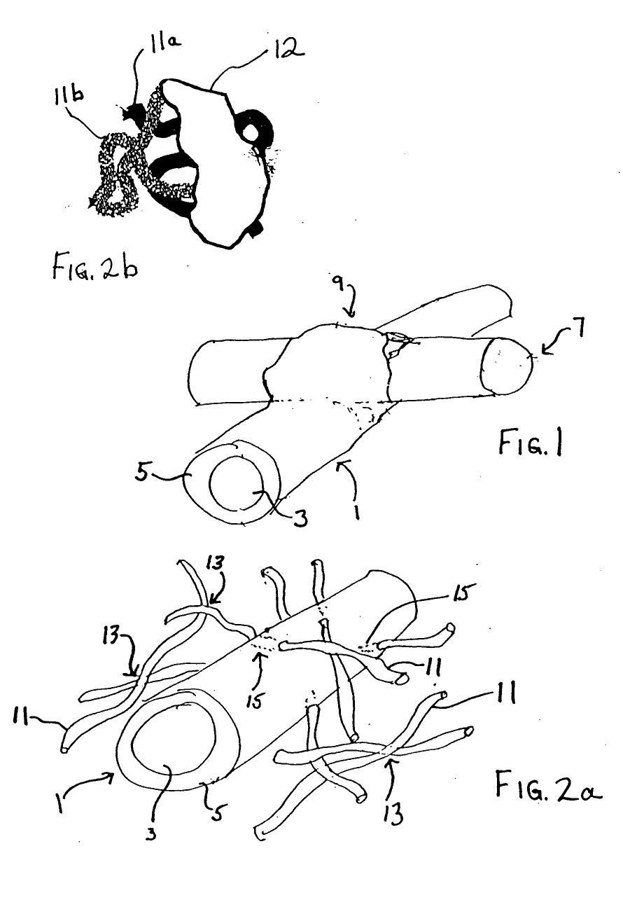

### DETAILED DESCRIPTION

While the invention will be described in connection with specific and preferred embodiments, it will be understood that it is not intended to limit the invention to those embodiments. To the contrary, it is intended to cover all alterations, modifications and equivalents as may be included within the spirit and scope of the invention as defined by the appended claims.

Throughout the present specification, where materials and methods are described as including or comprising specific components or specific processing steps, it is contemplated by the inventors that materials and methods of the present invention also consist essentially of, or consist of, the recited components or recited processing steps.

The present invention is described in terms of fibers, including staple fibers. “Fibers” according to the present invention is used to mean both fibers of finite length and substantially continuous structures, such as filaments.

The present invention contemplates a fiber-containing material made from multi-component fibers, and a method of making this material. These multi-component fibers include at least first and second segments respectively of first and second thermoplastic polymer materials having different melt temperatures, the first and second segments having been split from each other. The fiber-containing material is thermally bonded by melting the first or second polymer material having the lower melt temperature, without melting the first or second polymer material having the higher melt temperature.

Through the use of the splittable multi-component fibers, with the segment having lower melt temperature (binder fibers) being split from the other segment, more even binder distribution for more even appearance, increased bonded surface area resulting in increased fabric strength, and less wasted binder material, are achieved.

A difference in melt temperature between the first and second polymer materials of multi-component fibers of the fiber-containing material of the present invention is, illustratively, at least 10° C., e.g., in a range of 10°-250° C. Accordingly, the lower melting temperature polymer material can be completely melted, during thermal bonding in forming the fiber-containing material, without melting the higher melt temperature polymer material. Thus, the fabric can easily and effectively be thermally bonded by melting and re-solidifying the, e.g., micro-denier (less than 1 denier per filament) low-melt-temperature segment fibers, split from the high-melt-temperature segment fibers.

According to a further aspect of the present invention, the present invention also contemplates a multi-component fiber having first and second segments which are splittable from each other, respectively made of first and second thermoplastic polymer materials which are different polymer materials having different melt temperatures. A difference in melt temperature between the first and second polymer materials is at least 100° C.

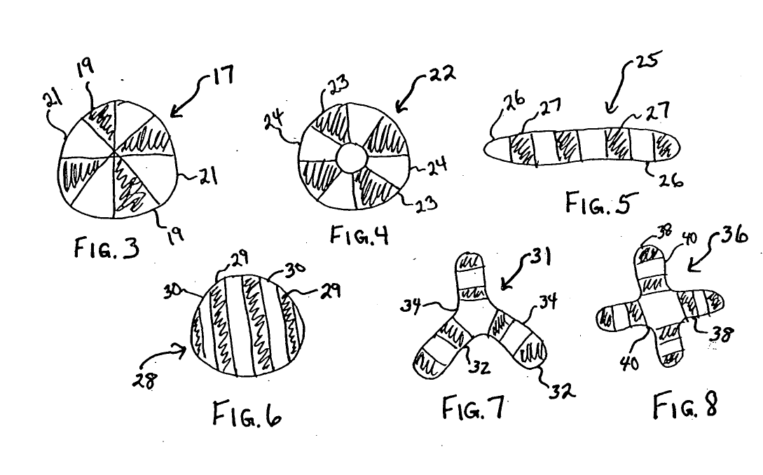

The multi-component (e.g., bicomponent) fibers according to the present invention can have various cross-sectional shapes. While not limiting, various of these cross-sectional shapes are illustrated in FIGS. 3-8. For example, FIG. 3 shows fiber 17 having a substantially round cross-section with eight wedge-shaped segments, the wedge-shaped segments being ultimately formed of two different polymers, such that adjacent segments are formed of different polymers. In FIG. 3, the round fiber 17 has segments 19, 21 respectively of different polymer materials. Fibers having this cross-section and methods of making them are disclosed in U.S. Pat. No. 3,117,362, the contents of which are incorporated herein by reference in their entirety.

FIG. 4 illustrates a multi-component fiber 22 which is hollow; that is, wedge-shaped segments 23, 24, respectively of different polymer material, do not extend completely to the center. The fiber shown in FIG. 4 can be made using the same extrusion technique as the fiber shown in FIG. 3, but with a spinneret that produces a hollow fiber. Fibers of this type are disclosed in U.S. Pat. No. 4,051,287 and No. 4,109,038, the contents of each of which are incorporated herein by reference in their entirety.

FIG. 5 discloses a multi-component fiber 25 which is in the shape of a ribbon in cross section, having alternating polymer A segments 26 and polymer B segments 27 (polymer A and polymer B being different polymers, of different melt temperatures and forming segments which are splittable from each other) disposed side-by-side.

FIG. 6 shows conjugate fiber 28 having alternating polymer A segments 29 and polymer B segments 30 disposed side-by-side, fiber 28 having a circular cross section.

FIG. 7 shows fiber 31 with a segmented trilobal cross-section, with alternating polymer A segments 32 and polymer B segments 34.

FIG. 8 shows fibers 36 having a cross-sectional shape of a segmented cross, with alternating polymer A segments 38 and polymer B segments 40.

Suitable apparatuses for forming multi-component fibers of the various cross-sections illustrated in FIGS. 3-8 are known within the art, and can be utilized for forming the multi-component fibers according to the present invention.

Various polymers which can be used for the fiber segments of low melt temperature and for the fiber segments of high melt temperature are described in the following.

Thus, low melt temperature polymer materials can include isophthalic acid-modified copolyesters and other copolyesters, polybutylene terephthalate (PBT), polylactic acid (PLA), high density polyethylene (HDPE), linear low density polyethylene (LLDPE), polypropylene (PP), co-polyolefins, co-polyamides, polystyrene, polyurethanes, acetals, ionomers, polymethyl methacrylate (PMMA), poly-ethylene vinyl alcohol (EVOH), polyvinyl alcohol (PVOH), polyvinyl chloride (PVC), polyvinylidene chloride (PVDC), polyether block amide, polycaprolactone (PCL), polyethylene terephthalate (PET)-glycol, polytrimethylene terephthalate (PTT), polyethylene terephthalate (PET), polyamides, and blends, alloys and copolymers of these polymers.

The high melt temperature polymer materials can include copolyesters, PBT, PLA, PP, polymethylpentene (PMP), polystyrene, polyurethanes, acetals, ionomers, PMMA, cyclo-olefin copolymer (COC), syndiotactic polystyrene (SPS), polyacrylonitrile (PAN), liquid crystal polymers (LCP), PVC, PVDC, PTT, PET, polyamides, poly-cyclohexylene dimethylene terephthalate (PCT), polyethylene naphthalate (PEN), polyketone, polyether-ether ketone (PEEK), polyphenylene sulfide (PPS), polyphenylene oxide, polysulfone and fluoro polymers.

As can be appreciated from the foregoing, there is a wide overlap between polymer materials for the low melt temperature segments and for the high melt temperature segments, as some of the higher melt temperature polymers, among the listed low melt temperature polymers, may be used in combination with even lower melt temperature polymers.

Desirably, the low melt temperature segments are made of a material selected from the group consisting of HDPE, LLDPE, PP, PLA, copolymers of PET or polyamides; and the high melt temperature segments are made of PET, PLA, PCT or polyamides.

The multi-component (composite) fibers, prior to splitting, are illustratively between 0.7 and 100 denier per filament (dpf), and are more desirably between 1.5 and 50 dpf, most desirably between 2 and 15 dpf. The corresponding fiber diameters depend on the density of the polymers used, and whether the fiber has a hollow core. In general, illustratively the diameters would fall between 8 and 100 microns, desirably between and 12 and 90 microns and most desirably between 14 and 50 microns. These diameters, of course, relate only to fibers with a circular cross section. For multi-component fibers with other cross sections, dimensions (but not dpf ranges) would differ.

After splitting, the split fiber dimensions would depend again on polymer densities, as well as on the number of segments in the multi-component fiber and the degree to which all the segments split apart. Illustratively, the multi-component fibers would have between 4 and 100 segments, desirably between 12 and 40 segments. Multi-component fiber deniers and the number of segments would typically be chosen to produce post-split fiber dpf values from about 0.01 to 20 dpf, corresponding to average diameter ranges between about 1.4 and 60 microns.

However, post-split fiber (segment) size and degree of splitting will have an effect on characteristics of the fiber-containing material of the present invention, formed from the post-split fibers. For example, where, according to the present invention, post-split fiber values are above about 2.5 dpf (that is, the post-split fibers are relatively large), and where the split low melt temperature material fibers are completely separated (split) from the split high melt temperature material fibers, various advantages (previously discussed) resulting from more finely-divided binder fibers at more cross-over points would not be achieved, since webs formed using these large post-split fibers would be similar to webs formed by blending standard fibers with standard binder fibers. However, even as compared with webs blending standard fibers with standard binder-fibers, these fiber-containing materials, using post-split fibers, according to the present invention, containing completely split fibers of relatively large size, would have an added advantage of an assurance of more intimate blending of binder and non-binder fibers. Moreover, in cases where the post-split fibers are split less than fully split, other advantages of the present invention can be achieved at post-split dpf values of, e.g., up to 8 dpf.

As stated previously, the fiber-containing materials according to the present invention are formed from multi-component fibers with segments which are splittable from each other and wherein the segments are respectively made of polymer materials having different melt temperatures. Melt temperatures for the lower melt temperature polymer illustratively will be about 60° C.-300° C., preferably 80° C.-260° C. and most preferably 110° C. to about 175° C. The range of melt temperatures for the polymer of higher melt temperature would illustratively be about 125° C. to 450° C., preferably 155° C. to about 320° C., most preferably about 170° C. to about 270° C. Difference in melt temperatures between the high melt temperature polymer and low melt temperature polymer can be as little as 10° C. or as much as 250° C., e.g., from 30° C. to 100° C.

As described previously, according to a further aspect of the present invention there are multi-component fibers of at least first and second segments of at least first and second polymer materials, respectively, these first and second polymer materials having different melt temperatures, the difference in melt temperatures being at least 100° C.

Many different types of webs or fabrics can be made as the fiber-containing (fibrous) material according to the present invention. For example, hydroentangled fabrics can be formed, prior to thermal bonding. Spunbonded fabrics (formed by spinning continuous segmented filaments onto a belt, and using heat and/or jets of fluid (for example, air, water or steam) to split the segments apart either prior to or after depositing the filaments on the moving belt, and subsequently thermally bonding the fabric either in an oven or by contact with heated rolls, and cooling the fabric) can be formed. This process of forming spunbonded fabrics might also include an intermediate fabric-forming step such as needle-punching, before thermal bonding. Thus, the fiber-containing material, in being collected, can be subjected to bonding (e.g., hydroentangling, needlepunching, stitchbonding, etc.), to add coherence to the web to make it a fabric, prior to the thermal bonding.

Another specific fabric which can be formed as the fibrous material according to the present invention is a wet-laid fabric, formed using traditional wet-laying processes, formed from short-cut staple segmented fibers and thermal bonding in an oven or on hot rolls after drying after the wet-laying process. In this process, the segments can be split prior to wet-laying, by heat or mechanical action or simply in the drawing, crimping, cutting and, optionally, aging processes, or can be split by mechanical action or heat (such as agitation in a slurry or use of hot water in the slurry) in the wet-laying step, or can be split by heat or fluid jets between wet-laying and thermal bonding.

Another specific fabric or web which can be formed is an air-laid nonwoven, formed using segmented staple fibers which are split prior to air-laying, or the fibers could be split by fluid jets and/or heat after air-laying, the fabric or web then being thermally bonded.

Another fabric or web according to the present invention is a web wherein segmented staple fibers are carded and the card web subsequently needle-punched. The segments could be split apart by heat and/or fluid jets either before or after needle-punching; the needle-punching itself could be used to split some of the fibers. The needle-punched, split fibers could then be thermally bonded.

Other fiber-containing materials, including fabrics or webs, within the contemplation of the present invention, utilizing multi-component fibers of a plurality of segments as discussed in the foregoing, include a card web of segmented staple fibers split using heat and/or fluid jets and subsequently thermally bonded; a yarn formed entirely from segmented filaments or a blend of segmented filaments with other filaments, the yarn being subjected to heat and/or mechanical agitation to split the segmented filaments and the yarn then being thermally bonded to add strength and abrasion resistance to the yarn; and a yarn formed by yarn-spinning segmented staple fibers either alone or in combination with other staple fibers, the segmented fibers being split and the yarn thermally bonded.

The apparatus and processing techniques for forming the fibrous materials according to the present invention, utilizing multi-component fibers having segments which are splittable from each other and which are made of materials having different melt temperatures, correspond to apparatus and processing steps used conventionally, and would not necessitate great changes in production lines similarly, apparatus and processing techniques corresponding to those suitably used in the art can be used in forming the multi-component fibers according to the present invention.

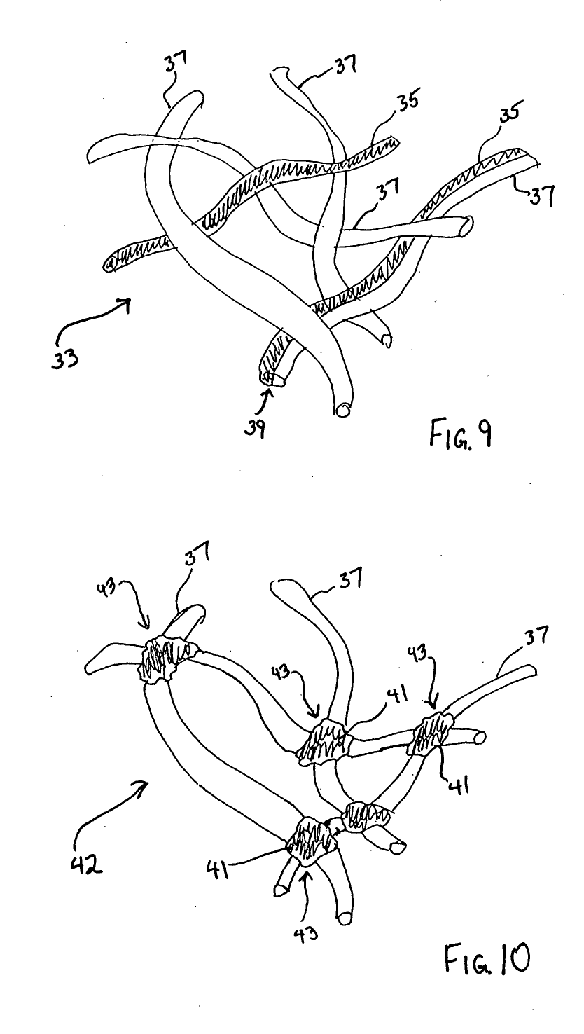

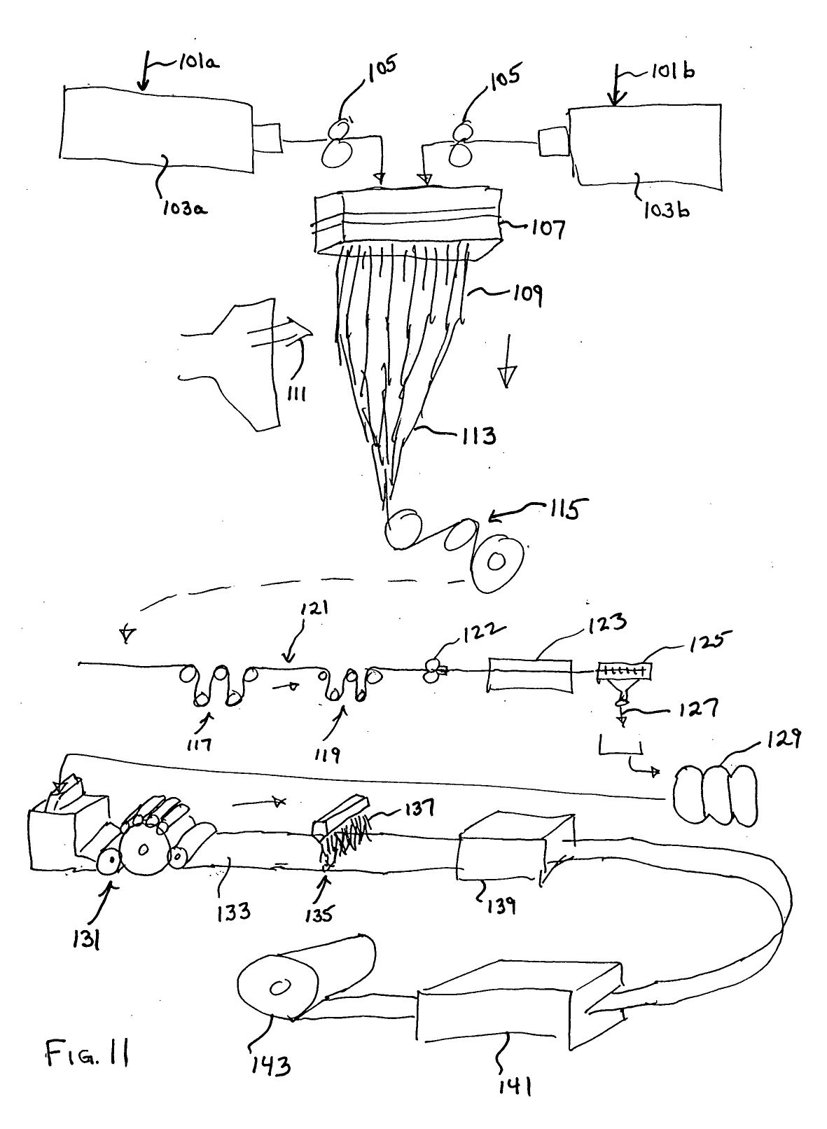

As mentioned previously, fibrous materials according to the present invention can have improved strength and softness, due, e.g., to the low melt temperature polymer of the second segments, after thermal bonding, encapsulating cross-over points of the first segments and being substantially only located at the cross-over points. This can be seen from FIGS. 9 and 10. In FIG. 9, web 33 is shown, after splitting of the multi-component fibers but prior to thermal bonding. Web 33 includes segments 35 of low melt temperature polymer and segments 37 of high melt temperature polymer. FIG. 9 shows one segment (microfiber) 35 of low melt temperature polymer totally separated from segments (microfibers) 37 of high melt temperature polymer. FIG. 9 also shows microfiber 39, having segments 35, 37 which are still joined.

FIG. 10 shows the web 42 after thermal bonding. The segments 37 of polymer of higher melt temperature are still shown as microfibers. However, the polymer of low melt temperature, after thermal bonding (where in the thermal bonding the polymer 41 of low melt temperature has been completely melted), has encapsulated cross-over points 43 of the segments 37 of higher melt temperature.

Fabrics according to the present invention can have a broad range of fabric weights, illustratively, from about 0.3 to 40 ounces per square yard, more specifically, a fabric weight in a range of about 1.0 to 15 ounces per square yard.

As described previously, the present invention also includes a method of making the fiber-containing material that includes the multi-component fibers. This method includes steps of splitting the second segments of the multi-component at least partially from the first segments, and thermally bonding the fibers by melting the second polymer material of the second segments. Desirably, the second polymer material of the second segments is completely melted, in the thermal bonding step.

In the splitting step, the second segments can be partially split from the first segments, or can be completely split from the first segments. Where the first and second segments are completely split from each other, the binder fibers (e.g., microfibers) are separate and distinct from the “to be bound” fibers (e.g., microfibers).

Where the multi-component fibers are split into groups of two, three or more still partially connected segments, the binder fibers are carried in side-by-side configuration with the fibers of higher melt temperature. In this circumstance, with the segments being attached, where the segments are split by methods (e.g., thermal methods) employing differential shrinkage of the materials comprising adjacent segments many post-split fibers will comprise still-adjacent pairs of segments in side-by-side arrangement. In this case, in addition to providing dispersed binder fibers, the paired-segment microfibers can be self-bulking due to differential shrinkage. Thus, not only is thermal bonding improved (that is, providing a structure with increased strength and softness), but also self-bulked fabrics can be achieved.

FIG. 11 illustrates a process according to the present invention, for providing thermally bonded fabric from multi-component fibers. In FIG. 11, 101a, 101b show the feed respectively of polymer A (a higher melt temperature polymer) and polymer B (a lower melt temperature polymer). Polymers A and B are extruded respectively through extruders 103a, 103b and are moved by pumps 105 to spinneret pack 107, as suitable in the art. Spinneret pack 107 forms multiple fibers each having segments of both polymer A and polymer B (e.g., bicomponent cross-sections). Molten spun fibers 109 contact cooling air 111 and solidify, forming individual solid fibers 113. The fibers are then taken up by take-up device 115 (for example, a winder or tow-canner), and the solid fibers 113 (undrawn) are then passed to godets 117, 119. Godet 117 is 1× speed, and godet 119 is 3× speed. The difference in speed causes drawing of the fibers at 121. Thereafter, the drawn fibers are passed through crimper 122 and oven 123. The fibers are then passed through cutter 125, to form staple fibers, and the cut, crimped staple fibers 127 are baled, to become baled fiber 129.

Thereafter, the baled fiber is passed to carding device 131, forming carded web 133. Carded web 133 is passed to hydroentangling device 135, having water jets 137, where carded web 133 is hydroentangled and the segments split apart. The hydroentangled web is then dried in dryer 139 and then bonded in thermal bonding oven 141. Thereafter, the bonded web is taken up by fabric take-up 143.

The foregoing description of the process is merely illustrative of a method of forming a fabric or web according to the present invention, and is not to be limiting.

In the following is set forth a specific example of forming fiber-containing material according to the present invention. This example is merely illustrative of the present invention and is not limiting.

Initially, bicomponent filaments were extruded using a bicomponent extrusion system, with polyethylene terephthalate as the higher melt temperature polymer material for one set of segments and nylon 6 as the lower melt temperature polymer material for the second set of segments of the bicomponent filaments. The filaments were extruded with a “pie wedge” segmented cross section, as seen in FIG. 3. The filaments were taken up and drawn over heated godets with an overall draw ratio of 4:1, for a final linear density of 3 denier per filament. The drawn filaments were crimped, heat set and cut to a length of two inches (staple fibers). These staple fibers were carded to form a nonwoven web which was subsequentially subjected to high-pressure water jets (hydroentangling) which split the segments apart and entangled the fibers. After drying, the nonwoven fabric is heated in an oven at a temperature and with a dwell time to melt the nylon 6 sufficiently to encapsulate adjacent polyethylene terephthalate segments in bodies of nylon 6. Upon cooling, the nylon 6 re-solidifies and binds the fabric, giving it high strength and high softness.

Alternatively, the nylon 6 as the low melt temperature material can be replaced with polypropylene.

In the foregoing example, the high melt temperature material of one set of segments was polyethylene terephthalate and the low melt temperature polymer material of the other set of segments was nylon 6. Desirably, the high melt temperature material is polyethylene terephthalate, and the low melt temperature material is high density polyethylene. Desirably, the fibers utilized in forming fabrics are 3 denier, 1½-inch crimped staple fibers. Desirably, the multi-component fibers have a “pie wedge” cross section with no hollow core (note FIG. 3 herein), and the fibers are not split before fabric formation, but are carded and then split in hydroentangling. After hydroentangling, the fabric is thermally bonded in a continuous process in an oven.

As can be appreciated from the foregoing, the multi-component fibers according to the present invention are useful in forming the fiber-containing material (for example, fabrics) of the present invention. The fabrics are useful as filters (smaller fibers provide improved filtration, and the improved strength improves durability of the filter), as wiping cloths (smaller fibers pick up dirt more effectively, higher strength improves durability, and improved softness can cause less abrasion damage to the surface being cleaned (for example, lens wipes)) and in synthetic leathers and suedes (microfibers aid in reproducing the feel of leather and suede, and improved strength improves durability and abrasion resistance).

In addition, any thermally bonded nonwoven fabric in need of higher strength can be improved by replacing conventional binder fibers with multi-component fibers of splittable segments of polymers having different melt temperatures as in the present invention. This allows conventional thermally bonded nonwovens to be made with less weight for a given strength, or with higher overall strength. Higher strength allows the nonwoven fabric to be subsequently processed (for example, in a diaper-forming operation) at higher speeds, since many process line speeds are limited by the breaking strength of the webs used.

Accordingly, by the present invention fibrous materials are provided with improved strength and softness. Since, according to the present invention, smaller amounts of adhesive are placed at more bonding sites, and because there are more bonding sites formed, a more even appearance is achieved, with less wasted binder material, in addition to the aforementioned greater strength and softness. Moreover, there is little or no productivity loss, when utilizing multi-component fibers or fibrous materials as in the present invention.

While we have shown and described several embodiments in accordance with the present invention, it is understood that the same is not limited thereto, but is susceptible of numerous changes and modifications as known to those skilled in the art. For example, alternate embodiments include melt-blown fabrics using multi-component fibers as in the present invention, or use of continuous filament forms. Moreover, fiber-containing materials according to the present invention can be formed using other fibers together with multi-component fibers of the first and second segments respectively of higher and lower melt temperature materials as described herein, the segments of lower melt temperature material melting (e.g., completely melting) and bonding the segments of higher melt temperature material and the other fibers at, e.g., cross-over points thereof. Therefore, we do not wish to be limited to the details shown and described herein, but intend to cover all such changes and modifications as are encompassed by the scope of the appended claims.

1. A method of forming a fiber-containing material, comprising the steps of:
collecting a plurality of multi-component fibers, the multi-component fibers having at least first segments and second segments respectively made of first and second polymer materials different from each other, the first polymer material having a higher melt temperature than that of the second polymer material;
splitting the second segments at least partially from the first segments; and
thermally bonding the fibers, to form the fiber-containing material, by melting the second polymer material of the second segments.

2. The method according to claim 1, wherein in thermally bonding the fibers, the second polymer material of the second segments is completely melted.

3. The method according to claim 1, wherein in the step of splitting the second segments from the first segments, the second segments are only partially split from the first segments.

4. The method according to claim 1, wherein in the step of splitting, the second segments are completely split from the first segments.

5. The method according to claim 1, wherein in the collecting step the plurality of multi-component fibers are collected into a yarn.

6. The method according to claim 1, wherein in the collecting step the plurality of multi-component fibers are deposited on a collecting surface so as to form a nonwoven web.

7. The method according to claim 1, wherein the multi-component fibers are staple fibers.

8. The method according to claim 1, wherein the first and second segments are split by applying heat thereto.

9. The method according to claim 8, wherein in the step of splitting the second segments from the first segments, the second segments are only partially split from the first segments.

10. The method according to claim 9, wherein the first and second segments are subject to differential shrinkage upon application of heat, the fibers being self-bulking due to the differential shrinkage.

11. The method according to claim 1, wherein in the collecting step the plurality of multi-component fibers are collected on a collecting surface and bonded so as to form a nonwoven fabric.

12. The method according to claim 1, wherein the multi-component fibers are microfibers.

13. The method according to claim 1, wherein each of the multi-component fibers contains 4-100 segments and is in a range of 0.7-100 deniers per filament, and after splitting the segments are in a range of 0.01-20 deniers per filament.

14. The method according to claim 1, wherein a difference in melt temperature between the first and second segments is at least 100° C.

15. The method according to claim 1, wherein the melt temperature of the first segments is in a range of 125°-450° C., and the melt temperature of the second segments is in a range of 60⁰-300° C., the difference in melt temperature between the first and second segments being in a range of 10″-250° C.

16. The method according to claim 1, wherein in the collecting step, the plurality of multi-component fibers form cross-over points with each other, and in the thermal bonding step the second polymer material of the second segments is melted so as to encapsulate the first segments at the cross-over points.

17. The method according to claim 16, wherein in the thermal bonding step the second polymer material of the second segments is melted such that after the thermal bonding the second polymer material of the second segments is substantially only at the cross-over points.

18. The method according to claim 1, wherein in the thermal bonding the second polymer material of the second segments is melted without melting the first polymer material of the first segments.

19. The method according to claim 1, wherein the splitting is performed by applying jets of fluid to split the first and second segments apart.

20. The method according to claim 1, wherein the splitting is performed by subjecting the multi-component fibers to mechanical action.

21. The method according to claim 1, wherein in the thermal bonding step the second polymer material of the second segments is the only bonding agent for the fiber-containing material.

22. The method according to claim 1, wherein the collecting is performed prior to the splitting.

23. The method according to claim 1, wherein the splitting is performed prior to the collecting.
